(19) United States
(12) Patent Application Publication
(10) Pub. No.: US 2015/0205034 A1
(43) Pub. Date: Jul. 23, 2015

(54) LIGHT GUIDE PLATE COMPRISING DECOUPLING ELEMENTS

(71) Applicant: Bayer MaterialScience AG, Monheim Am Rhein (DE)

(72) Inventors: Thomas Fäcke, Leverkusen (DE); Friedrich-Karl Bruder, Krefeld (DE); Rainer Hagen, Leverkusen (DE); Günther Walze, Leverkusen (DE); Thomas Rölle, Leverkusen (DE); Horst Berneth, Leverkusen (DE); Dennis Hönel, Zulpich-Wichterich (DE); Marc-Stephan Weiser, Leverkusen (DE); Werner Hoheisel, Koln (DE)

(21) Appl. No.: 14/420,959

(22) PCT Filed: Aug. 9, 2013
(86) PCT No.: PCT/EP2013/066687

§ 371 Date: Feb. 11, 2015

(30) Foreign Application Priority Data
Aug. 13, 2012 (EP) 12180247.4

(51) Int. Cl. F21V 8/00

(52) U.S. Cl. CPC G02B 6/0051; G02B 6/0061

(57) ABSTRACT

The invention relates to a planar light distribution module for a display, comprising a light guide plate through which light coupled in via at least one side face can propagate by means of total reflection, and at least one out-coupling device (2), which is applied on one or both of the main faces of the light guide plate (1), is in optical contact therewith and has a multiplicity of holographic optical elements (13) formed therein, which are configured in such a way that they can couple light out of the light guide plate (1), the light distribution module being characterized in that the holographic optical elements (13), independently of one another, have an extent of at least 300 μm in at least one spatial axis extending parallel to the surface of the out-coupling device (2). The invention furthermore relates to an optical display, in particular an electronic display.

The invention relates to a planar light distribution module for a display, comprising a light guide plate through which light coupled in via at least one side face can propagate by means of total reflection, and at least one out-coupling device, which is applied on one or both of the main faces of the light guide plate, is in optical contact therewith and has a multiplicity of holographic optical elements formed therein, which are configured in such a way that they can couple light out of the light guide plate. The invention furthermore relates to an optical display, in particular an electronic display, having a light distribution module.

Liquid-crystal displays have become widely used. They exist in many sizes. They range from small LC displays in mobile telephones and game computers, through medium-sized displays for laptops, tablet PCs or desktop monitors, up to large applications such as for televisions, advertising panels and building installations.

Conventionally, cold cathode light sources and light-emitting diodes (LEDs) are used for generating light in the rear illumination unit (backlight unit, abbreviated to BLU). The emission characteristic of these light sources is such that they emit relatively nondirectional light. Essentially, two designs are used: direct lighting and edge lighting.

In direct lighting (direct BLU), the light sources are mounted on the rear side of the display. This has the advantage that the light is distributed very homogeneously over the size of the display panel, which is important particularly for televisions. If LEDs are furthermore used in direct lighting, these can also be dimmed, which allows an increased contrast value of the display. A disadvantage is the high costs, since a multiplicity of light sources are necessary.

For this reason, edge lighting has recently become more widespread on the market. In this case, the light sources are mounted only on the edges of a light guide plate. The light is coupled in at the edge and is transported internally by total reflection. By light out-coupling elements fitted on the flat side of the light guide plate, the light is directed forwards in the direction of the LC panel. Typical light out-coupling elements are in this case printed patterns of white ink, roughening of the surface of the light guide plate or embossed light-refracting structures. The number and density of these structures can be selected freely and allow very homogeneous illumination of the display.

In the further development of high-resolution LC displays, attempts are made to find ways of enabling more energy-saving displays having better image qualities. One important partial aspect is in this case enlargement of the colour space (gamut) and homogeneous lighting (light density distribution).

The colour space can be enlarged by increasing the colour fidelity of the individual pixels. This is associated with the use of increasingly narrow spectral distributions of the red, green and blue pixels. Narrowing the spectral distribution of the colour filters is conceivable, but this is to the cost of the light efficiency and increases the energy consumption. It is therefore advantageous to use light sources with narrow spectral emission, for example light-emitting diodes or laser diodes.

The light out-coupling elements used in the current prior art, for example white reflection ink or surface roughening, exhibit the nondirectional scattering behaviour of a Lambertian emittor. This leads on the one hand to a multiplicity of light paths, which need to be homogenized again by the diffuser and prism films positioned between the light guide plate and the LC panel, and then redirected in order to provide a light distribution appropriate for the LC panel.

Besides these reflective or refractive out-coupling elements, diffractively acting surface structures on the light guide plate have been described:

US 2006/0285185 describes a light guide plate in which the depth of the diffractive surface structure formed therein is adapted to the efficiency of the out-coupling. The effective efficiency, however, is regarded as low owing to only one frequency in the grating structure.

US 2006/0187677 teaches a light guide plate in which the diffractive surface structures formed therein are intended to adjust a homogeneous intensity distribution by a different fill factor and different orientations.

US 2010/0302798 discloses the use of two spatial frequencies through superstructures into the diffractive surface structure. US 2011/0051035 teaches similar adaptation by further cutaway in the surface structure, in order to be able to optimize out-coupling properties separately from the out-coupling efficiencies.

Park et al. (Optics Express 15(6), 2888-2899 (2007)) report dot-matrix diffractive point-like surface structures but, however, thereby only achieve an intensity uniformity of 62%.

U.S. Pat. No. 5,650,865 teaches the use of double holograms, which consist of a reflection and a transmission volume hologram. The two holograms select light from a narrow spectral width and direct light from a particular angle perpendicularly out of the light guide plate. The double holograms for the three primary colours are in this case geometrically assigned to the pixels of an LC panel. The orientation of two pixelated holograms with respect to one another, and their adjustment with respect to the pixels of the LC panel, is in this case elaborate and difficult.

US 2010/0220261 describes illumination devices for liquid-crystal displays, containing a light guide plate which contains volume holograms, in order to redirect laser light. In this case, the volume holograms are positioned at special distances with respect to one another, obliquely in the light guide plate. The production of volume holograms in light guide plates, however, is very cost-intensive.

GB 2260203 discloses the use of volume holograms as colour-selective gratings on a light guide plate, individual volume holograms having out-coupling efficiencies which increase along the incidence direction. The colour-selective gratings are in this case spatially adapted to the pixels of a light-transmissive digital light modulator, which for higher-resolution display panels is becoming more and more elaborate and therefore expensive.

Furthermore, manufacturing costs applying the aforementioned methods increase considerably for future ever higher-resolution displays. In particular, exact orientation of the grating points on the ever-smaller pixels of these display becomes more and more challenging.

It was therefore an object of the present invention to provide an improved display design with a particularly flat and compact light distribution module, which can project light efficiently and homogeneously onto a light-transmissive digital light modulator. The light distribution module should furthermore make it possible to reduce the number of light sources, and therefore render the production of optical displays more economical. The light distribution module should furthermore be suitable for use in high-resolution displays.

In the case of a light distribution module of the type mentioned in the introduction, this object is achieved by a planar light distribution module for a display, comprising a light guide plate through which light coupled in via at least one side face can propagate by means of total reflection, and at least one out-coupling device, which is applied on one or both of the main faces of the light guide plate, is in optical contact therewith and has a multiplicity of holographic optical elements formed therein, which are configured in such a way that they can couple light out of the light guide plate, the light distribution module being characterized in that the holographic optical elements, independently of one another, have an extent of at least 300 μm in at least one spatial axis extending parallel to the surface of the out-coupling device and an area at least 1.5 times as great as the pixels of the display.

The invention is in this case based on the discovery that, in contrast to previously conventional designs, discrete assignment of the holographic optical elements to an individual pixel of a display is not necessary, so that the individual holographic optical elements can have a significantly larger surface extent than the pixels of the display. Such a light distribution module can be manufactured more simply and with less overall height, but nevertheless makes it possible to achieve uniform lighting of the individual pixels even in high-resolution displays—that is to say ones having correspondingly small pixels. For example, the holographic optical elements of a light distribution module according to the invention have an area at least 1.5 times as great as the pixels of the display, in particular an area which is at least 2 times or 3 times as great.

In other words, when using a light distribution module according to the invention, it is accordingly not necessary for the holographic optical elements to light a discrete pixel of a display. Instead, by using such larger holographic optical elements, diffuse and uniform lighting of a display background is possible.

Thus, in the case of the light distribution module according to the invention, the light can be coupled out of the light guide plate directionally, and the homogeneous light out-coupling can be achieved by the distribution of the holographic optical elements on the light guide plate. In addition, for example, the shape, size, diffraction efficiency and/or diffraction direction of the holographic optical elements may be varied, or wavelength selection may be carried out with the aid of the holographic optical elements.

In other words, typically used light sources couple the light into the light guide plate in a wide angle range. In this case, the holographic optical elements select beams and leave those beams which do not follow the Bragg condition in the light guide plate. By skilful selection of the shape and size or the diffraction efficiency or of the distribution of the holographic optical elements over the light guide plate or by the diffraction direction or by wavelength selection, or by a combination of two or more of these properties, it is possible to adjust the light homogeneity uniformly on a diffuser. The light guide plate is therefore used as a light reservoir, from which the holographic optical elements “extract” light and couple it out expediently to the diffuser. This and other possibilities will be dealt with in more detail below.

Plasma emission lamps are suitable as light sources for the inventive displays, for example cold cathode fluorescent lamps or other plasma light sources, containing for example exciplex; solid-state light sources, for example light-emitting diodes (LEDs) based on inorganic or organic materials, preferably so-called white LEDs, which contain ultraviolet and/or blue emission and colour-converting phosphors, in which case the colour-converting phosphors may also contain such semiconducting nanoparticles (so-called quantum dots, Q-dots), which—as is known to the person skilled in the art—after excitation with blue or UV light emit with high efficiency in the suitable red and green and optionally blue wavelength ranges. Q-dots providing very narrow light emission bandwidths as possible are preferred. Furthermore, combinations of at least three monochromatic, i.e. for example red, green and blue, LEDs are also suitable; combinations of at least three monochromatic, i.e. for example red, green and blue, laser diodes; or combinations of monochromatic LEDs and laser diodes, so that the primary colours can be reproduced by combination are also suitable. As an alternative, the primary colours may also be generated in a rail-like element which is illuminated with blue LEDs and contains suitable Q-dots in order to mix converted red and green light with a narrow bandwidth with high efficiency with the blue light of the LED. The rail-like element, also available under the registered trademark “Quantum Rail”, may be positioned in front of an array of blue LEDs or blue laser diodes.

The production of the holographic optical elements in the transparent layer is possible by means of various methods. It is possible to use a mask corresponding to the pattern to be generated, the mask containing openings (positive mask) which correspond to the pattern. In this case, the holographic exposure is set up by locally modifying either the signal beam or the reference beam, or both, in its intensity or polarization by the mask. This mask may inter alia be made of metal, plastic, strong paperboard or the like, and therefore contains openings or regions at which the beam is transmitted or its polarization is changed, and generates a holographic optical element by means of interference with the second beam in the holographic recording film. In regions where only one beam strikes the recording material, or where the polarization states of the two beams are mutually orthogonal, recording material exposure does not lead to recording of a holographic optical element takes place.

If locally different diffraction efficiencies are intended to be produced for the holographic optical elements, then it is possible to use a grey filter which locally adapts the beam ratio of signal-to-reference beam and therefore varies the amplitude of the interference field, which determines the diffraction efficiency of the holographic optical element, from position to position. The grey filter may, for example, be produced by a printed glass plate or transparent plastic film, which is substantially free of birefringence, which is placed onto the mask. Ideally, the grey filter is produced by a digital printing technique, for example ink-jet printing or laser printing.

Besides a grey filter, it is also possible to use an element which locally varies the polarization state of at least one of the two writing beams, as the amplitude of the interference field can therefore also be influenced. Suitable elements would, for example, be linear polarizers, quarter-wave or half-wave plates. Linear polarizers can also act as grey filters.

If it is desired to expose not only a simple holographic grating but also a diffuser property jointly into the holographic optical element, then the signal beam may be modified by an optical diffuser. The mask may in this case be placed onto the diffuser in order to permit the spatial assignment there. Likewise, it is also possible to modify the reference beam similarly with the mask. In the latter case, the “signal” information is divided between the reference and signal beam, since the reference beam with the mask defines the region and the signal beam introduces the diffuser property. Furthermore, it is possible first to produce a master hologram of the diffuser, which is used in a second holographic exposure step in order to produce the actual holographic optical elements in the transparent layer. If a master hologram is used, the positive mask is only needed for the production thereof, and it may optionally be obviated when subsequently making copies.

The out-coupling devices of the light distribution module may for example be made by masking methods (positive mask), by varying the beam ratio using a grey filter, a polarization filter, by using a diffuser, by incoherent preexposure through a grey filter (negative mask), or by sequential optical printing of individual holographic optical elements, to mention only some examples. Modification of the out-coupling devices may for example be carried out by erasing holograms using radiation, chemical swelling or reduction, by mechanical finishing or by a combination of two or more of these methods.

If it is desired to use different layers having holographic optical elements, it may be advantageous to produce these separately and then apply them on one another in a lamination step or by an adhesive bonding method. If different holographic optical elements with different diffraction angles are used, a separate mask is used for each of these groups and the beam geometry is correspondingly modified. In this case, the exposures are carried out sequentially.

If different holographic optical elements are used for different reconstruction frequencies, then a separate mask and a different laser is used for each of these groups. In this case, the exposures may be carried out sequentially. It is likewise possible to provide each mask opening with a colour filter, which defines the colour assignment. The exposure may then be carried out sequentially as well as simultaneously by means of a white laser consisting of red, green and blue. If the absorption of the colour filter is furthermore varied for the transmitted beam as well, the diffraction efficiency can also be adapted simultaneously.

If the holographic optical elements adjoin one another or mutually overlap, then the mask can be entirely obviated and the glass plate/plastic film may be used on its own for the exposure.

Besides a positive mask, a negative mask may also be used. In this case, the regions which are exposed are desensitized by incoherent preexposure. After this preexposure, the actual holographic exposure is carried out in the remaining regions of the recording film. The incoherent preexposure may in this case be carried out with a different light intensity. In this way, it is possible to adjust each region from no desensitizing to full desensitizing.

The subsequent holographic exposure may then again be carried out colour-selectively and/or direction-selectively, so that in this way the diffraction efficiency is adjusted by the incoherent preexposure by means of a negative mask, while the colour selectivity and/or the direction selectivity are formed in the second step using the positive mask. The desensitizing of the recording medium is carried out using a negative mask, so that the regions without a holographic optical element are thereby defined. Subsequently, the red, green and blue holographic optical elements are written sequentially into the recording material with the respective lasers. Likewise, it is possible to provide each positive mask opening with a colour filter, which defines the colour assignment. The exposure may then be carried out sequentially as well as simultaneously by means of a white laser consisting of red, green and blue.

In another method, which is suitable for producing holographic optical elements in the out-coupling device, each holographic optical element is optically printed sequentially. In this case, using an x-y displacement table, either the recording material is moved past an optical writing head or the optical writing head is guided over the recording material by means of an x-y positioning unit. In this case, each position is addressed individually and the holographic optical element is exposed therein by means of interference exposure. The method is in this case also suitable in particular for easy adaptation of the reconstruction directions of the individual holographic optical elements, since easy adaptation is possible by rotating the optical writing head or the recording material. The writing head may naturally also contain further functions, such as colour selectivity by using a plurality of lasers or with flexible greyscale filters or polarization elements, which can adapt the signal-reference beam ratio.

It is also within the scope of the invention first to apply a holographic optical element surface-wide onto the surface of the light guide plate, and in a subsequent step to structure it into individualized holographic optical elements by deliberately erasing the hologram in regions or locally influencing their diffraction properties for different wavelengths of the visible spectrum. This may for example, but not exclusively, also be carried out using a mask, for example by bleaching the hologram with LUV radiation or other erasure methods adapted to the recording material.

Furthermore, for example, the diffraction property of the holographic optical elements may be adapted to different wavelength ranges of the visible spectrum via x-y scanning by controlled local swelling or reduction. Suitable agents would, for example, be monomers crosslinkable by actinic radiation and having a suitable refractive index, which locally diffuse in and are then crosslinked. This procedure may preferably be employed when using photopolymers as the recording material.

Lastly, it is possible to produce the holographic optical elements by means of a stampable and transferable film material. In this case, a uniform grating structure is exposed, and the structure of the pattern is mechanically stamped out and transferred onto the waveguide, for example by means of a lamination step.

The out-coupling device preferably consists of a recording material for volume holograms. Suitable materials are, for example, silver halide emulsions, dichromatic gelatins, photorefractive materials, photochromic materials or photopolymers. Of these, essentially silver halide emulsions and photopolymers are of industrial relevance. Very bright and contrast-rich holograms can be written into silver halide emulsions, although increased outlay is necessary for protection of the moisture-sensitive films in order to ensure sufficient longterm stability. For photopolymers, there are a plurality of basic material concepts, a common feature of all photopolymers being the photoinitiator system and polymerizable writing monomers.

Furthermore, these constituents may be embedded in carrier materials, for example thermoplastic binders, crosslinked or uncrosslinked binders, liquid crystals, sol-gels or nanoporous glasses. In addition, further properties may be deliberately adjusted in a controlled way by special additives. In a particular embodiment, a photopolymer may also contain plasticizers, stabilizers and/or other additives. This is advantageous particularly in connection with crosslinked matrix polymers containing photopolymers, such as are described for example in EP2172505A1. The photopolymers described therein have a photoinitiator system modularly adjustable to the necessary wavelength as photoinitiator, writing monomers having actinically polymerizable groups and a highly crosslinked matrix polymer. If suitable additives are added, selected as described in WO 2011/054796, it is possible to produce particularly advantageous materials which offer an industrially beneficial material in terms of their optical properties, producibility and processability. Suitable additives according to this method are in particular urethanes, which are preferably substituted with at least one fluorine atom. These materials can be adjusted over wide ranges in terms of their mechanical properties, and can therefore be adapted to many requirements both in the unilluminated and in the illuminated state (WO 2011054749 A1). The photopolymers described can be produced either by roll-to-roll methods (WO 2010091795) or by printing methods (EP 2218742).

The out-coupling device may furthermore have a layer structure, for example an optically transparent substrate and a layer of a photopolymer. In this case, it is particularly expedient to laminate the out-coupling device comprising the photopolymer directly onto the light guide plate. It is likewise possible to configure the out-coupling device in such a way that the photopolymer is enclosed by two thermoplastic films. In this case, it is particularly advantageous for one of the two thermoplastic films, which adjoins the photopolymer, to be applied on the light guide plate by means of an optically clear adhesive film.

The thermoplastic film layers of the out-coupling device preferably consist of transparent plastics. Substantially birefringence-free materials, such as amorphous thermoplastics, are particularly preferably used in this case. Polymethyl methacrylate, cellulose triacetate, amorphous polyamides, amorphous polyester, amorphous polycarbonate and cycloolefins (COC), or blends of the aforementioned polymers, are suitable in this case. Glass may also be used for this.

The out-coupling device may furthermore contain silver halide emulsions, dichromatic gelatins, photorefractive materials, photochromic materials and/or photopolymers, in particular photopolymers containing a photoinitiator system and polymerizable writing monomers, preferably photopolymers containing a photoinitiator system, polymerizable writing monomers and crosslinked matrix polymers.

In another configuration of the light distribution module according to the invention, the holographic optical elements are arranged irregularly in the out-coupling device. This is particularly advantageous because uniform lighting is achieved in this way. This is important because, depending on the type, number and orientation of the light sources with which light is fed into the light distribution module, different radiation conditions prevail in the light guide plate. These differences can be compensated for by the aforementioned measure. In other words, this configuration of the invention does not require a uniform arrangement of the holographic optical elements in order to permit uniform coupling of light out of the light guide plate.

An irregular arrangement of the holographic optical elements in the out-coupling device is intended in particular to mean that no two-dimensional repetition sequence exists for the arrangement of the holographic optical elements in the out-coupling device; in other words, it contains no regularly repeating, equidistant arrangement of the holographic optical elements.

An aperiodic arrangement of the holographic optical elements may, for example, be described by a physical model, in which a regular point grating with a point spacing a is assumed as the initial configuration, each point corresponding to a holographic optical element. Each point of the grating is assigned a point mass, which is connected to each of its four nearest neighbours by a tension spring. These tension springs are prestressed by a certain amount, which means that the resting length of the springs is less than the average distance between the grating points.

The spring constants of the springs are statistically distributed around an average value. Subsequently, the minimum of the energy of the overall system is determined. The point mass positions resulting from this form a grating having the desired properties:

The average distance between two neighbouring points is still a. The grating is aperiodic. There is no privileged direction and the autocorrelation function decreases rapidly for values greater than a. The slope of the decrease can be controlled by the spread of the values of the spring constants.

In order to be able to calculate the autocorrelation function of the grating, a function must initially be assigned to this grating. This may be done by all points (x, y) which lie on the lines of the grating being assigned the value 1 and all other points being assigned the value 0. For this function f(x, y), the autocorrelation function can be determined in a manner known per se (see, for example, E. Oran Brigham, FFT/Schnelle Fourier-Transformation [Fast Fourier Transform], R. Oldenbourg Verlag, Munich/Vienna 1982, p. 84 ff.):

$$Z ( x , y ) = \frac{{\int }_{- ∞}^{∞} {\int }_{- ∞}^{∞} f ( {x}^{*} , {y}^{*} ) \cdot f ( {x}^{*} + x , {y}^{*} + y ) d {x}^{*} d {y}^{*}}{{\int }_{- ∞}^{∞} {( f ( {x}^{*} , {y}^{*} ) )}^{2} d {x}^{*} d {y}^{*}}$$

In the case of a strictly periodic grating, such as a square grating of edge length a, the function Z(x, y), at all points with x=n*a or with y==n*a, with n being an integer, has maxima of respectively equal amplitude independently of the value n. As soon as this grating is deformed in such a way that the proximity is preserved, but the far-field order is not, the amplitude of the maxima decreases rapidly with changing n.

An arrangement of the holographic optical elements which is organized in this way has the advantage that it is visually less apparent than a periodic grating. Owing to this, the average grating spacing can be selected to be greater and the production costs can be reduced. Furthermore, owing to the greater average grating line spacing, the light transmissivity of the out-coupling device is increased. Furthermore, the occurrence of a Moiré effect is suppressed.

In an advantageous configuration of the light distribution module according to the invention, the holographic optical elements are arranged in such a way that the number of holographic optical elements per unit area increases from at least one edge in the direction of the middle of the out-coupling device. This arrangement applies, in particular, for those edges of the out-coupling device which correspond to a side surface of the light guide plate, on which light from a light source is coupled in. To this extent, when there are two light sources arranged on the opposite side faces of the light guide plate, the number of holographic optical elements per unit area may thus increase from these two opposite edges in the direction of the middle of the out-coupling device. If light sources are arranged on three or four side faces of the light guide plate, then the aforementioned distribution applies accordingly. If the light sources are point light sources, then an increased number of out-coupling elements near the edge of the light guide plate, respectively between the point light sources, is additionally advantageous. The configuration is carried out similarly when one or more light sources are positioned on the edges of the light guide plate.

In the light distribution module according to the invention, there are a multiplicity of holographic optical elements in the out-coupling device. In the context of the present invention, a multiplicity is intended to mean the presence of at least 10 holographic optical elements in the out-coupling device, preferably at least 30 holographic optical elements, preferably at least 50, more preferably at least 70, particularly preferably at least 100.

In another embodiment of the light distribution module according to the invention, the holographic optical elements are formed in the out-coupling device and extend from one of the flat sides of the out-coupling device into the latter and/or pass fully through it. In such an embodiment, it is particularly preferable for the out-coupling device to be in contact with that flat side which has the light guide plate on which the holographic optical elements are located. In this way, particularly effective optical contact between the light guide plate and the out-coupling device can be produced, so that the out-coupling efficiency of the holographic optical elements is improved.

In the scope of the present invention, the out-coupling device or the light guide plate may furthermore be provided with a reflection layer, which is applied on the flat side lying opposite the light out-coupling direction. This may, for example, be carried out by applying a metallic reflection layer by vapour deposition, sputtering or other techniques. In this way, the out-coupling efficiency can be increased, or an intensity loss can be reduced.

According to another preferred embodiment of the light distribution module according to the invention, the diffraction efficiency of the holographic optical elements differs, the diffraction efficiency of the holographic optical elements increasing in particular along the direction of incidence for light into the light guide plate from the edge of the out-coupling device. If opposite light sources are provided, the diffraction efficiency advantageously increases from the side edges on which the light sources couple the light into the light guide plate in the direction of its middle. If three or four side edges of the light guide plate are provided with light sources, the aforementioned arrangement with respect to the diffraction efficiency applies correspondingly. If the light sources are point light sources, then an increased diffraction efficiency near the edge of the light guide plate, respectively between the point light sources, is additionally advantageous.

In the scope of the present invention, it is particularly advantageous when the holographic optical elements can couple light out of the light guide plate at least in the wavelength range of from 400 to 800 nm. Irrespective of this, it is also possible to use holographic optical elements which cover a wider wavelength range. Conversely, it is also possible to use holographic optical elements which only cover a section of the visible wavelength range, in particular, for example, only the range of red, blue or green light, or optionally also yellow light. In this way, colour-selective out-coupling of individual light colours of white light from the light guide plate can be carried out. Consequently, a particularly preferred embodiment of the present invention consists of a light distribution module in which the holographic optical elements can couple light out wavelength-selectively, there being in particular at least three groups of holographic optical elements, which are respectively wavelength-selective for red, green and blue light, in which case a fourth group for yellow light may optionally also be used.

In another configuration of the light distribution module according to the invention, the holographic optical elements may be configured in such a way that the light coupled out by them passes fully through the out-coupling device transversely. In other words, transmissive out-coupling devices may thus be used. As an alternative or in addition to these transmissive out-coupling devices, the holographic optical elements may also be configured in such a way that the light coupled out is reflected and passes transversely through the light guide plate after being coupled out. In other words, this means that such a reflective out-coupling device is arranged on the flat side of the light guide plate lying opposite the emission direction of the light distribution module. In this case, a reflection layer may also be provided on the outer face of this type of reflective out-coupling device. This may, as mentioned above, consist of a vapour deposited or sputtered metal layer.

For the holographic optical elements used in the scope of the present invention, a multiplicity of possible configurational forms may be employed, configuration as volume gratings being particularly preferred. In another advantageous configuration of the light distribution module according to the invention, at least one out-coupling device may be arranged on both flat sides of the light guide plate, and/or at least two out-coupling devices may be arranged on one flat side of the light guide plate. If a plurality of out-coupling devices are provided on one of the flat sides of the light guide plate, it is furthermore preferred for at least three out-coupling devices to be arranged on one flat side of the guide plate, the three out-coupling devices respectively containing holographic optical elements wavelength-selective for precisely one light colour, in particular for red, green and blue light. In other words, in such an embodiment each of the three out-coupling devices selectively couples one light colour, namely for example red, green or blue light, out of the light guide plate.

The out-coupling device may have any thickness required for the intended function. In particular, with photopolymer layer thicknesses ≧0.5 μm, preferably ≧5 μm and ≦100 μm, particularly preferably ≧10 rpm and ≦40 μm, it is possible to achieve the effect that only particular selected wavelengths are diffracted. For example, it is possible to laminate three photopolymer layer thicknesses, each ≧5 μm, on one another and to write them separately in each case. It is also possible to use just one photopolymer layer ≧5 μm when at least three colour-selective holograms are written simultaneously, successively, or partially overlapping in time, into this one photopolymer layer. As an alternative to the options described above, it is also possible to use photopolymer layers ≦5 μm, preferably ≦3 μm and particularly preferably ≦3 μm and ≧0.5 μm. For this case, only one individual hologram will be written, preferably with a wavelength which is close to the spectral middle of the visible electromagnetic wavelength range or close to the geometrical average of the two wavelengths of the longest-wavelength and the shortest-wavelength emission range of the illumination system.

In another advantageous configuration of the light distribution module according to the invention, the holographic optical elements, independently of one another, have an extent of at least 400 μm, in particular at least 500 μm, preferably at least 800 μm or even at least 1000 μm in at least one spatial axis extending parallel to the surface of the out-coupling device. The use of such larger holographic optical elements permits diffuse and uniform lighting of a display background. Furthermore, such light distribution modules can be manufactured more easily.

The holographic optical elements, which are used for the light distribution module according to the invention, may have any desired shape. For instance, the holographic optical elements, independently of one another, may have a circular, elliptical or polygonal, in particular three, four, five or six-sided, trapezoidal or parallelogram-like cross section in the surface of the out-coupling device. The aforementioned extent of the holographic optical elements, in at least one spatial axis extending parallel to the surface of the out-coupling device, respectively means the smallest extent in the case of such shapes.

This configuration also includes embodiments in which the holographic optical elements are arranged, for example, in the form of strips which extend from one side edge of the out-coupling device to the opposite side edge. These strips may be arranged parallel to the side edges of the out-coupling device or at any other desired angle. In this case, the individual holographic optical elements configured in the form of strips extend in parallel to one another or at an angle.

According to another configuration possibility of the light distribution module according to the invention, the individual holographic optical elements of an out-coupling device partially overlap, the surface of the out-coupling device in particular being covered substantially fully with holographic optical elements.

Depending on the production method of the out-coupling device (for example by optical printing) it is possible to produce discrete holographic optical elements which adjoin one another or overlap with neighbouring holographic optical elements. For instance, more than two holographic optical elements may also overlap with one another and over one another. If other production methods are used (for example greyscale masks) there may also be no discrete boundaries between the holographic optical elements. In this case, the imaging performance (for example indicated by the resolution of the printing head, or the ink dosing for representation of a grey region) of the greyscale masks printing process determines the underlying size, shape, diffraction efficiency etc. of the holographic optical elements. The resolution of a printing process is typically specified in dpi=dots per inch, in the context of which it is assumed that at least 100 individual printing drops are needed for the definition of a holographic optical element by a grey mask.

In the scope of the present invention, the light distribution module may comprise a diffuser which is arranged on that flat side of the combination of the light distribution plate and out-coupling device on which the light is emitted, the diffuser preferably lying on the light guide plate and/or out-coupling device without optical contact being established. This is preferably achieved by means of a roughened surface or particulate spacers on the surface of the light guide plate or of the diffuser. The spacing set by the surface condition is preferably less than or equal to 0.1 mm, in particular less than or equal to 0.05 mm. A diffuser is an element in the form of a plate, comprises a scattering layer or consists thereof. In this way, a particularly uniform light distribution can be produced.

It is particularly advantageous when, in addition to the aforementioned first diffuser, a further diffuser is provided which is placed behind the first diffuser in the radiation direction, at a distance from and parallel thereto. For the further spacing, the preferred values mentioned above in relation to the first diffuser apply. In other words, a light distribution module according to the invention optionally comprises of one or more diffusers.

As an alternative or in addition to a diffuser, the holographic optical elements may likewise already inherently have a diffuser function. Such a function may be already imparted to the holographic optical elements by corresponding illumination techniques during production.

It is likewise possible to use only essentially blue-emitting light sources, and to configure the light distribution module according to the invention in such a way that light is homogeneously directed towards the light modulator L only for blue wavelengths, colour conversion being carried out in the colour filter of the light modulator for the red and green pixels using Q-dots. The advantage of this design is the high light efficiency, since the colour filter absorbs no light, but only converts, and because the configuration of the light distribution module is simplified by its monochromatically (blue) out-coupling device through the use of only one layer.

The present invention furthermore relates to an optical display, in particular a display of a television, mobile telephone, computer and the like, having a planar liquid-crystal module that comprises a multiplicity of pixels, which can be switched by means of a control unit, and a planar light distribution module which is in optical contact with the liquid-crystal module comprising a light guide plate through which light coupled in via at least one side face can propagate by means of total reflection, and at least one out-coupling device, which is applied on one or both of the main faces of the light guide plate, is in optical contact therewith and has a multiplicity of holographic optical elements formed therein, which are configured in such a way that they can couple light out of the light guide plate in the direction of the planar liquid crystal module, the display being characterized in that the holographic optical elements, independently of one another, have an extent in at least one spatial axis extending parallel to the surface of the out-coupling device which exceeds the extent of the pixels in at least one to the surface of the liquid-crystal module at least by the factor 1.5, preferably at least by the factor 1.8, more preferably at least by the factor 2.0, particularly preferably at least by the factor 2.5, more particularly preferably at least by the factor 3.0.

In a refinement of the optical display according to the invention, the display contains a light distribution module according to the present invention. Besides the light distribution module according to the invention, the displays according to the invention generally comprise a light-transmissive digital spatial light modulator and an illumination unit. Owing to the small overall height of the light distribution module according to the invention, it is suitable in particular for compact thin designs and energy-efficient displays, such as are required for televisions, computer screens, laptops, tablets, smartphones and other similar applications.

In a preferred configuration of the optical display according to the invention, said display contains only light sources essentially emitting blue light, colour conversion to green and red light being carried out by means of Q-dots in a quantum rail in the light source, in the holographic optical elements of the out-coupling device, in a diffuser or in a colour filter.

If the conventional rear display housing is obviated, and rear mirroring is not used, these illumination systems are also suitable in particular for transparent displays which have versatile applications in point-of-sale displays, advertising applications in window displays, in transparent information panels in airports, railway stations and other public places, in automobile applications in the roof liner and as information displays in and on the dashboard and the front window of a car, in window glass panes, in commercial refrigerators with transparent doors and other household appliances. If desired, it may also be configured as a curved or flexible display.

The invention will be explained in more detail below with the aid of the drawings. In the drawings,

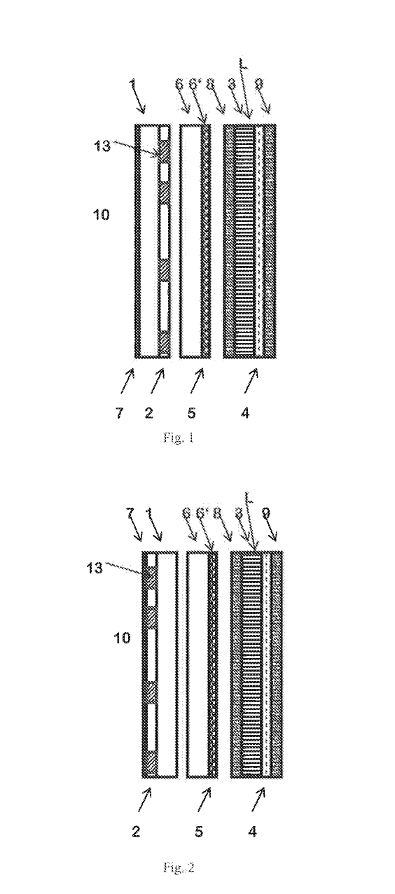

FIG. 1 shows a sectional view of a first embodiment of a display according to the invention having holographic optical elements in transmission mode,

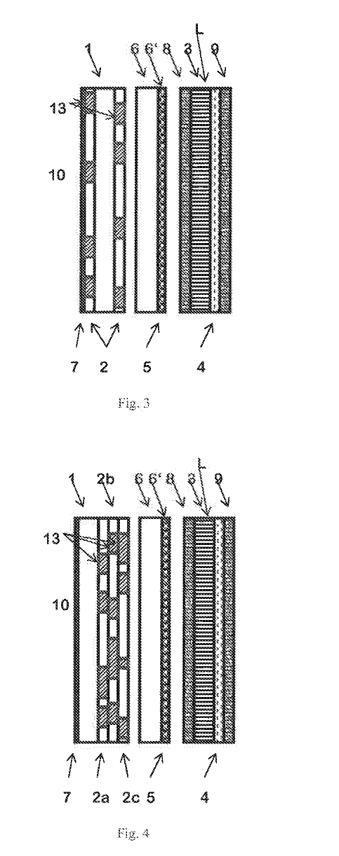

FIG. 2 shows a schematic side view of a second embodiment of a display according to the invention having holographic optical elements in reflection mode,

FIG. 3 shows a schematic side view of a third embodiment of a display according to the invention having holographic optical elements in transmission and reflection mode,

FIG. 4 shows a schematic side view of a fourth embodiment of a display according to the invention having three different types of holographic optical elements in transmission mode respectively for one primary colour,

FIG. 5 shows a schematic detail view of FIG. 1 with representation of two beam paths and diffuse, directional diffraction of one of the beams by a holographic optical element towards a diffuser (scattering plate) containing a transparent layer,

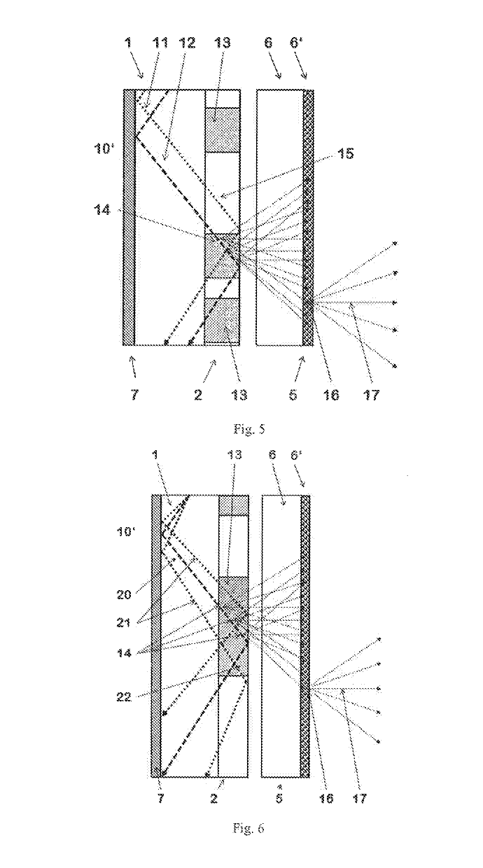

FIG. 6 shows a schematic detail view of FIG. 1 with representation of three beam paths with different angles of incidence and diffuse, directional diffraction of one of the beams by a holographic optical element,

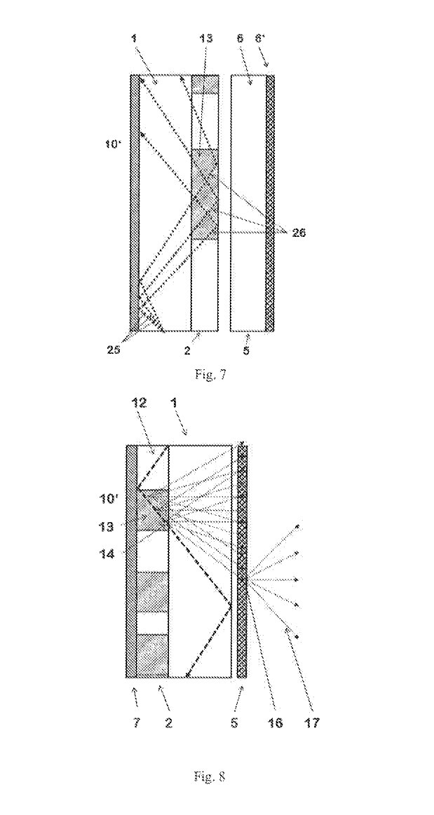

FIG. 7 shows a schematic detail view of FIG. 6 with representation of three beam paths with different angles of incidence from an opposite direction to FIG. 6 without diffraction of beams,

FIG. 8 shows a schematic detail view of FIG. 2 with representation of one beam path and diffuse, directional diffraction by a holographic optical element and use of an additional diffuser (scattering plate) without a further transparent layer,

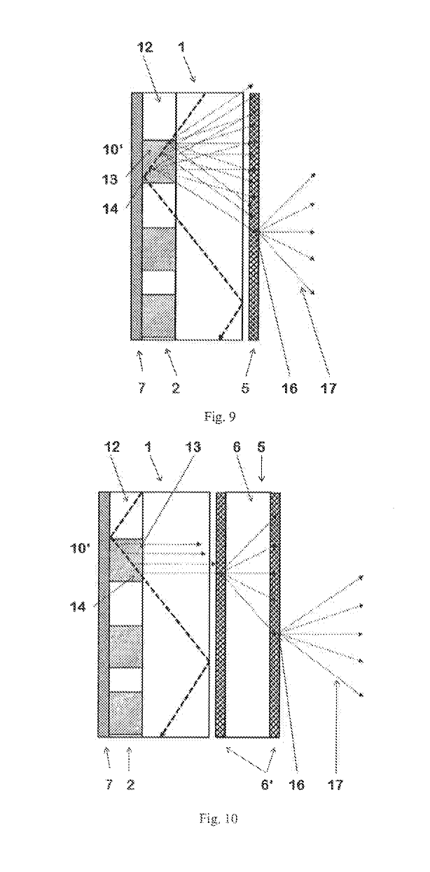

FIG. 9 shows an alternative configuration to FIG. 8 with a reflectively acting holographic optical element,

FIG. 10 shows a schematic detail view of FIG. 2 with representation of one beam path and exclusively directional diffraction by a holographic optical element and use of two additional diffusers (scattering plates) separated by a transparent layer,

FIG. 11 shows an alternative configuration to FIG. 9 with a reflectively acting holographic optical element,

FIG. 12 shows an out-coupling device having holographic optical elements with diffraction efficiency increasing along the incidence direction, in plan view obliquely from above,

FIG. 13 shows an out-coupling device having holographic optical elements with spacings decreasing along the incidence direction, in plan view obliquely from above,

FIG. 14 shows an out-coupling device having holographic optical elements with size increasing along the incidence direction, in plan view obliquely from above,

FIG. 15 shows an out-coupling device having rectangular holographic optical elements with a spacing decreasing in the transverse direction, in plan view obliquely from above,

FIG. 16 shows an out-coupling device having holographic optical elements which diffract light in mutually orthogonal planes, in plan view obliquely from above,

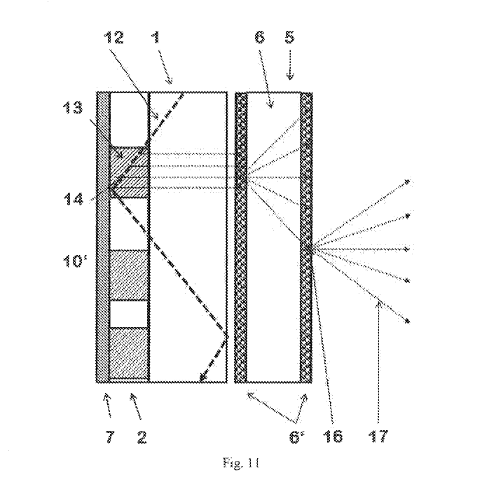

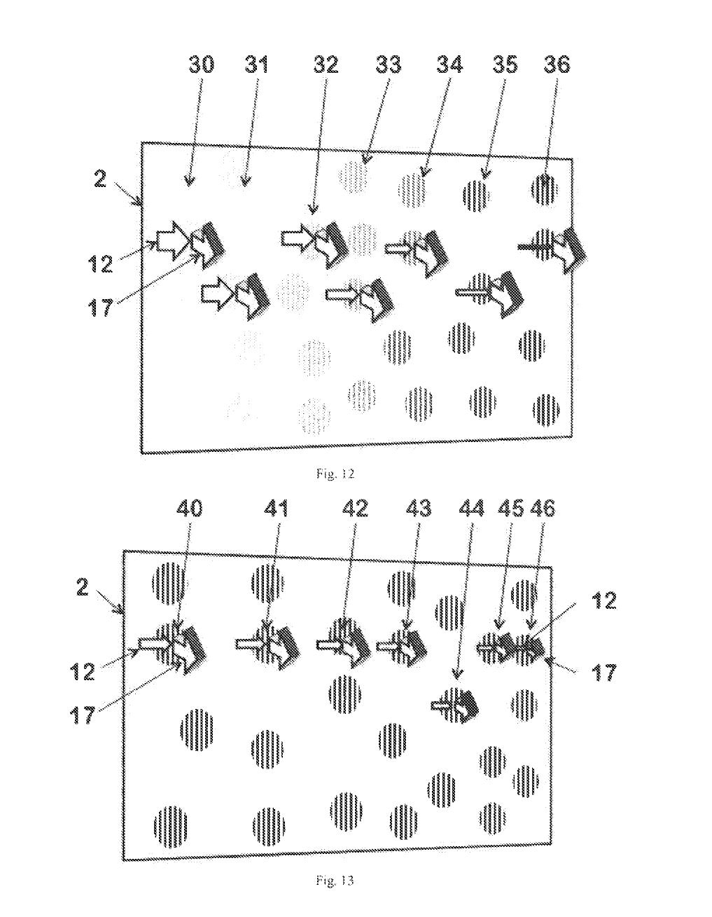

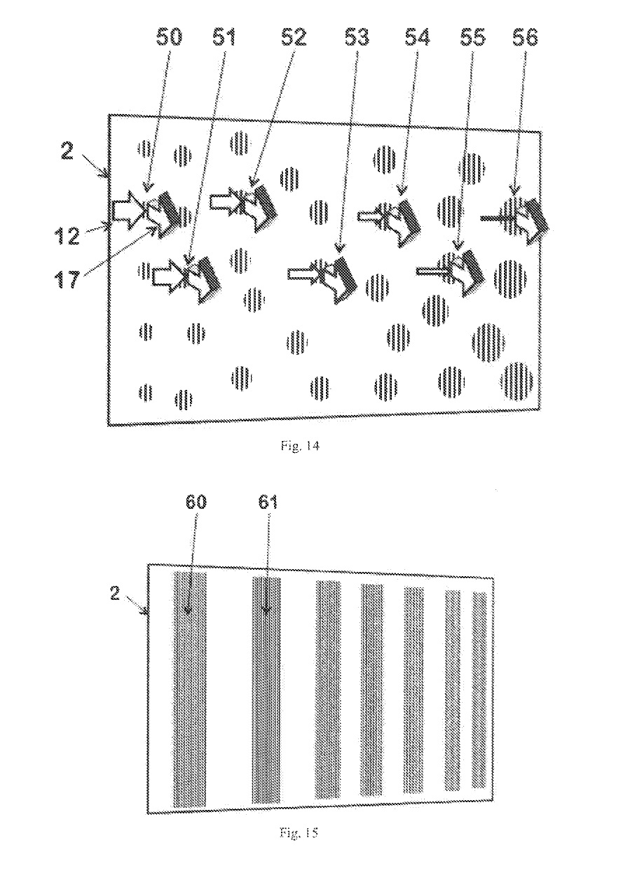

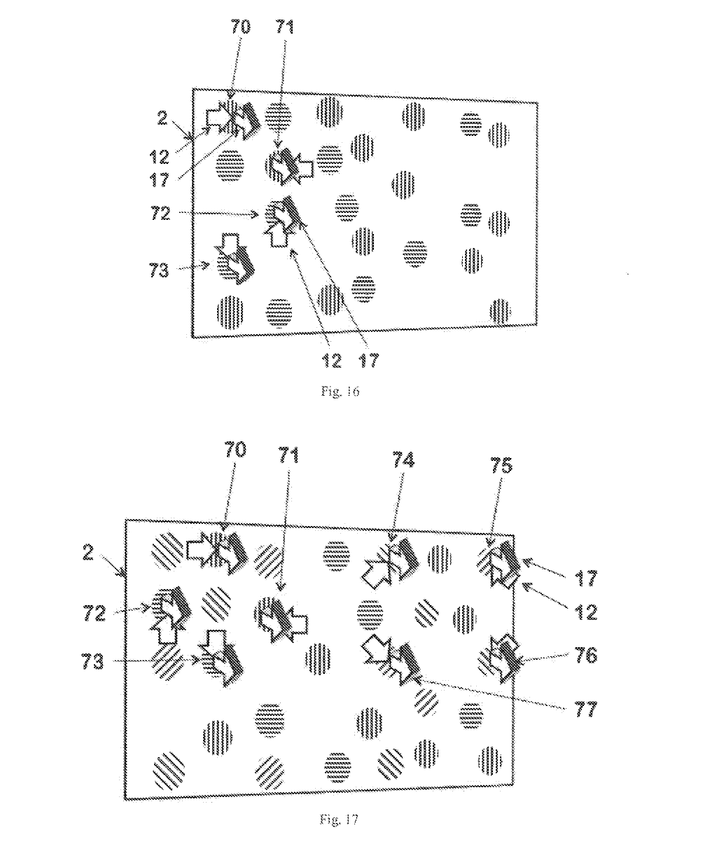

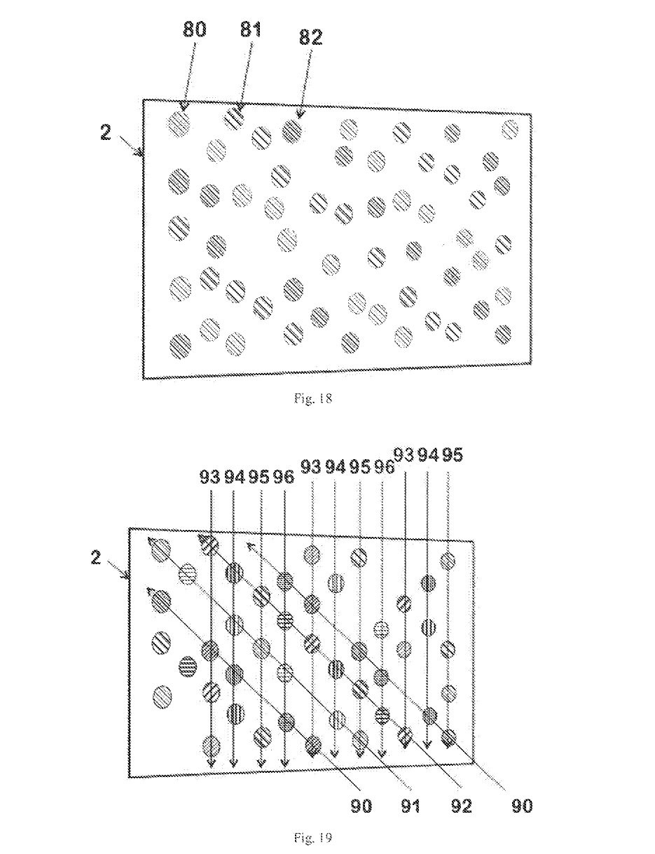

FIG. 17 shows an out-coupling device having holographic optical elements which diffract light in planes that are successively rotated in 45° steps with respect to one another, in plan view obliquely from above,

FIG. 18 shows an out-coupling device having holographic optical elements which diffract light of different frequency bands (wavelength bands), in plan view obliquely from above,

FIG. 19 shows an out-coupling device having holographic optical elements which successively diffract light of different frequency bands (wavelength bands), the planes in which they diffract light being successively rotated in 45° steps with respect to one another, in plan view obliquely from above,

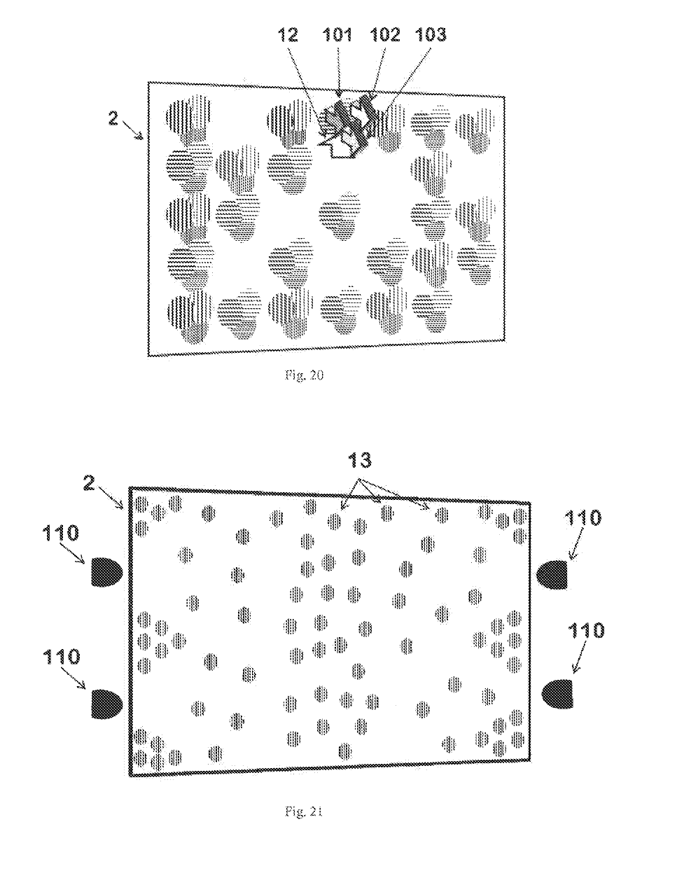

FIG. 20 shows an out-coupling device having partially overlapping holographic optical elements which are grouped into element sets and diffract light of varying frequency bands (wavelength bands), in plan view obliquely from above,

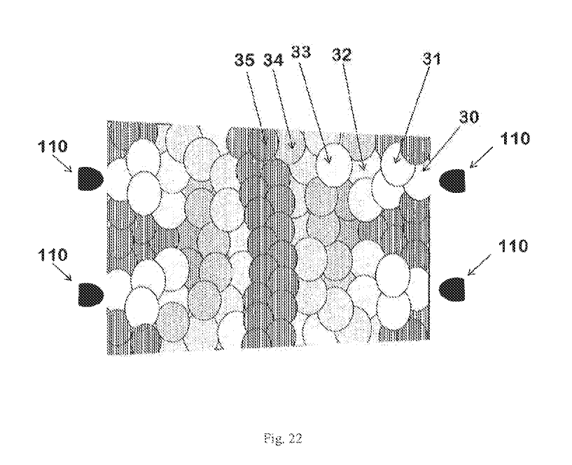

FIG. 21 shows an out-coupling device having a distribution of holographic optical elements of equal shape, diffraction direction, diffraction plane and diffraction efficiency, the distribution of the holographic optical elements ensuring a uniform light distribution of two light sources, which are placed on one or more end sides, in plan view obliquely from above,

FIG. 22 shows an out-coupling device having mutually adjoining and partially overlapping holographic optical elements, which have the same shape, diffraction direction and diffraction plane and a varying diffraction efficiency, which ensures a uniform light distribution of two light sources that are placed on one or more sites, in plan view obliquely from above.

According to a first preferred embodiment, as schematically shown in FIG. 1, the display 10 according to the invention consists of a light guide plate 1 and an out-coupling device 2 containing holographic optical elements 13 in the form of volume gratings in transmission mode. The volume gratings have an extent of for example 300 μm, 400 μm or even 1000 μm in a spatial axis extending parallel to the surface of the out-coupling device. The light guide plate 1 and the out-coupling device 2 are in this case in optical contact with one another. As represented here, the individual volume gratings are separated irregularly from one another, although the invention is not restricted to such an arrangement.

The light guide plate 1 consists of a transparent plastic, preferably an essentially birefringence-free amorphous thermoplastic, particularly preferably of polymethyl methacrylate or polycarbonate. The light guide plate is in this case between 50-3000 μm, preferably between 200-2000 μm and particularly preferably between 300-1500 μm thick.

The optical contact between the light guide plate 1 and the out-coupling device 2 may in this case be achieved by direct lamination of the out-coupling device 2 onto the light guide plate 1. It is likewise possible to establish the optical contact by means of a liquid, ideally a liquid which corresponds to the refractive index of the light guide plate 1 and of the out-coupling device 2. If the refractive indices of the light guide plate 1 and of the out-coupling device 2 differ, the liquid should have a refractive index which lies between those of the light guide plate 1 and of the out-coupling device 2. Such liquids should have a sufficiently low volatility to be used for permanent bonding. The optical contact may likewise be made possible by an optically clear (contact) adhesive, which is applied as a liquid. Likewise, the optical contact may be established by a transfer adhesive film. The refractive index of the optically clear adhesive and of the transfer adhesive should likewise ideally lie between that of the light guide plate 1 and that of the out-coupling device 2. Optical contact by means of a liquid adhesive and transfer adhesive film is preferred.

It is likewise possible optionally to mirror the light guide plate 1 on one side, preferably on the side which adjoins air, as may be achieved by metallization methods (for example laminating metal foils, metal vacuum deposition methods, application of a dispersion of colloids containing metal with subsequent sintering, or by applying a solution containing metal ions with a subsequent reduction step). In this case, a reflection layer 7 is produced which is likewise in optical contact with the light guide plate 1.

It is likewise possible to improve the waveguide properties with an especially lower refractive index, preferably on interfaces of the light guide plate 1 which are in direct optical contact with other transparent components and are not covered with holographic optical elements 13. Furthermore, it is possible to use multilayer constructs which have alternating refractive indices and layer thicknesses. Such multilayer constructs having reflection properties may comprise organic or inorganic layers, the layer thicknesses of which are of the same order of magnitude as the wavelength(s) to be reflected.

The out-coupling device 2 consists of a recording material for volume holograms 13. Typical materials are holographic silver halide emulsions, dichromatic gelatins or photopolymers. The photopolymer consists at least of a photoinitiator system and polymerizable writing monomers. Special photopolymers may also additionally comprise plasticizers, thermoplastic binders and/or crosslinked matrix polymers. Crosslinked matrix polymers comprising photopolymers are preferred. It is particularly preferred that the photopolymers consist of a photoinitiator system, one or more writing monomers, plasticizers and crosslinked matrix polymers.

The out-coupling device 2 may furthermore have a layer structure, for example an optically transparent substrate and a layer of a photopolymer. In this case, it is particularly expedient to laminate the out-coupling device 2 with the photopolymer directly onto the light guide plate 1.

It is likewise possible to configure the out-coupling device 2 in such a way that the photopolymer is enclosed by two thermoplastic films. In this case, it is particularly advantageous for one of the two thermoplastic films adjacent to the photopolymer to be bonded to the light guide plate 1 by means of an optically clear adhesive film.

The thermoplastic film layers of the out-coupling device 2 consist of transparent plastics. Preferably, essentially birefringence-free materials, such as amorphous thermoplastics, are used in this case. Polymethyl methacrylate, cellulose triacetate, amorphous polyamides, polycarbonate and cycloolefins (COC), or blends of the aforementioned polymers, are suitable for this. Glass may also be used for this.

In a preferred embodiment, the light distribution module comprises a diffuser 5, which consists of a transparent substrate 6 and a diffusely scattering layer 6′. The diffuser is in this case a volume scatterer. The diffusely scattering layer may consist of organic or inorganic scattering particles which do not absorb in the visible range, which are embedded in a coating layer and preferably formed quasi-spherically. The scattering particles and the coating layer in this case have different refractive indices.

In another preferred embodiment, the light distribution module comprises a diffuser 5, which consists of a transparent substrate 6 and a diffusely scattering and/or fluorescent layer 6′. The diffusely scattering or fluorescent layer may consist of organic or inorganic scattering particles which do not absorb in the visible range, which may be fully or partially replaced by red- or green- fluorescing Q-dots, and which are embedded in a coating layer. The scattering particles and the coating layer in this case have different refractive indices.

The display 10 according to the invention furthermore comprises a light-transmissive digital light modulator L, which is for example instructed as a liquid-crystal module consisting of a colour filter 4, polarizers 8 and 9 as well as a liquid-crystal panel 3. The liquid-crystal module may in this case have various designs, and in particular the liquid-crystal switching systems known to the person skilled in the art may be used, which can achieve particular, advantageous and efficient light shadowing with different beam geometries. Particular attention is given to twisted nemnatic (TN), super twisted nematic (STN), double super twisted nematic (DSTN), triple super twisted nematic (TSTN, film TN), vertical alignment (PVA, MVA), in-plane switching (IPS), S-IPS (super IPS), AS-IPS (advanced super IPS), A-TW-IPS (advanced true white IPS), H-IPS (horizontal IFS), E-IPS (enhanced IPS), AH-IPS (advanced high performance IFPS) and ferroelectric pixel-based light modulators.

FIG. 2 shows a second configuration of a display 10 according to the invention, which differs from the first embodiment in FIG. 1 in that the out-coupling device 2 containing the holographic optical elements 13 is now arranged on the opposite side face of the light guide plate 1 and diffracts light in reflection mode.

FIG. 3 shows a third embodiment of a display 10 according to the invention, which differs from the first embodiment in FIG. 1 in that two out-coupling devices 2 having holographic optical elements 13 are arranged on the two flat sides of the light guide plate 1, the first out-coupling device 2 diffracting light in transmission mode and the other out-coupling device 2 diffracting light in reflection mode.

FIG. 4 shows a fourth embodiment of a display 10 according to the invention, which differs from the first embodiment in FIG. 1 in that three out-coupling devices 2a, 2b, 2c are arranged above one another on one flat side of the light guide plate 1, each of these out-coupling devices 2a, 2b, 2c containing holographic optical elements 13 which diffract light in transmission mode. In this case, it is possible for each of the out-coupling devices 2a, 2b, 2c to diffract only one of the primary colours “red”, “green” and “blue”, or for them to diffract all wavelength components of visible light. The wavelengths of the primary colours red, green and blue are determined by the emission wavelength of the light used. It is also possible to use more than three primary colours “red”, “green” and “blue”, for example also “yellow” and the like.

The use of a plurality of holographic optical elements 13, which diffract light only for particular selected light sources (for example red, green and blue), is possible in particular with photopolymer layer thicknesses >5 am. In this case, it is possible to laminate three photopolymer layers, each >5 μm, and write each of them separately beforehand. It is likewise possible to use just one photopolymer layer >5 μm, but to write all three colour-selective holographic optical elements 13 therein simultaneously or successively. It is furthermore possible to use photopolymer layers <5 μm, preferably <3 μm and particularly preferably <3 μm and >0.5 μm. For this case, only one holographic optical element 13 will be written, preferably with a wavelength which lies in the spectral middle of the visible electromagnetic wavelength range. This one wavelength, with which the holographic optical element 13 is written, may likewise lie at the geometrical average of the two wavelengths of the long-wave light source and the short-wave light source. It is likewise to be taken into account that economical and sufficiently strong laser devices are available. Frequency-doubled Nd:YVO₄ crystal lasers at 532 nm and an argon ion laser at 514 nm are preferred.

The simplest holographic optical elements 13 consist of diffractive gratings, which diffract light by refractive index modification corresponding to the grating. The grating structure is in this case produced photonically in the entire layer thickness of the recording material by exposure using two interfering, collimated and mutually coherent laser beams. They differ from so-called surface holograms (embossed holograms) in that the diffraction efficiency is theoretically higher and can be up to theoretically 100%, the frequency selectivity and angle selectivity is adjusted by the active layer thickness and in that, through the geometries of the holographic exposure, there is substantial freedom to adjust the corresponding diffraction angle (Bragg condition).

The production of volume holograms is known (H. M. Smith in “Principles of Holography” Wiley-Interscience 1969) and can be carried out, for example, by two-beam interference (S. Benton, “Holographic Imaging”, John Wiley & Sons, 2008).

Methods for the mass production of reflection volume holograms are described in U.S. Pat. No. 6,824,929, a light-sensitive material being positioned onto a master hologram and subsequently copied by means of coherent light. The production of transmission holograms is also known. For example, U.S. Pat. No. 4,973,113 describes a method of roll replication.

In particular, reference may be made to the production of edgelit holograms, which require special exposure geometries. Besides the introduction by S. Benton (S. Benton, “Holographic Imaging”, John Wiley & Sons, 2008, Chapter 18) and an overview of conventional two- and three-stage production methods (see Q. Huang, H. Caulfield, SPIE Vol. 1600, International Symposium on Display Holography (1991), p. 182) reference is also made to WO 94/18603, which describes edge illumination and waveguide holograms. Furthermore, particular production methods based on a special optical adapter block are disclosed in WO 2006/111384.

The holographic optical elements 13 contained in the exposure unit according to the invention with directional laser light are preferably edgelit holograms. These are particularly preferred volume gratings since they operate with steeply incident light, which is coupled in with total reflection.

FIG. 5 shows a detail of the structure in FIG. 1. The light beams 11 and 12 coupled in by the light source in this case follow the total reflection and propagate in the light guide plate 1. The interface between the light guide plate 1 and air, or the optional reflection layer 7 on one side and the interface of the out-coupling device 2 containing the holographic optical elements 13 and air serves as the total reflection interface. If the out-coupling device 2 contains further thermoplastic layers (for example as protection or a substrate film), then the total reflection takes place on the layer which has direct contact with the air.

When the light beam 11 passes through the out-coupling device 2, no light is diffracted since it does not pass through a diffractive optical element 13 (see position 15). The beam is likewise not diffracted in the further holographic optical element 13, as the Bragg condition is not satisfied there, while when the light beam 12 passes through the out-coupling device 2 in the holographic optical element 13, the light is diffracted in the direction of the light-transmissive digital spatial light modulator. In this case, the holographic optical element 13 simultaneously exhibits a diffuser property which was jointly exposed into it during the production of the holographic optical element 13.

The slightly widened diffuse light beam strikes the diffuser 5, constructed from a transparent layer 6 and a diffuser layer 6′, and is widened further. This diffuse widening is advantageous in order to permit substantially angle-independent observation of the display. What is important for the position of the holographic optical elements 13 is then the homogeneous light intensity at the location of the diffuser 5. The thickness of the transparent layer 6, the divergence angle of the diffraction of all the holographic optical elements 13 and the position of the light source(s) are involved in this. A person skilled in the art can determine the optimal distribution for a specific design by iterative simulation and tests.

FIG. 6 describes in detail the angle selection of the holographic optical element 13. Only the beam 20 is diffracted away in this case, while the light beams 21 with slightly different angles of incidence, which do not satisfy the Bragg condition, are not diffracted. If the holographic optical element 13 consists of a plurality of frequency-selective subholograms (i.e. for red, green and blue light), the layer thickness is to be selected >5 μm. The angle selection is in this case chosen so that it lies between 1-6°. The advantage of this method is the adaptation possibility of chromatic aberrations and general colour matching by individual adaptation of the diffraction efficiency for each colour.

If a layer thickness in the range of >0.5 μm to 5 μm is selected for the out-coupling device 2, an angle selection of about 5-30° is produced and a good diffraction efficiency is obtained for all visible light wavelength ranges.

Since light sources couple the light into the light guide plate 1 in a wide angle range, the holographic optical elements 13 select beams and leave those beams which do not satisfy the Bragg condition in the light guide plate 1. By skilful selection of the shape and size or the diffraction efficiency or of the distribution of the holographic optical elements 13 over the light guide plate or by the diffraction direction or by wavelength selection, or by a combination of two or more of these properties, it is possible to adjust the light homogeneity uniformly on the diffuser 5. The light guide plate 1 is therefore used as a light reservoir, from which the holographic optical elements 13 “extract” light and couple it out expediently to the diffuser 5.

FIG. 7 shows the similar light beams 25, which are all not diffracted since the holographic optical elements 13 diffract the light direction-selectively. Light beams which are reflected at the edge of the light guide plate 1 thus cannot be diffracted by the holographic optical element 13 (at the position 26). Only when they are reflected again at the other edge of the light guide plate 1 is further diffraction of the light possible.

FIG. 8 shows another inventive embodiment, in which a transmissively acting holographic optical element 13, which is read out in reflection, is used. The light beam 12 is shone into the light guide plate 1. After propagation by total reflection, it passes through the holographic optical element 13 in the out-coupling device 2 and is diffracted at the position 14 under the Bragg condition. The holographic optical element 13 diffracts the beam into a divergent diffuse beam which, after exiting the light guide plate 1, directly strikes the diffuser 5 which then again generates an angular dispersion so that there is homogeneous and divergent flat light during illumination of the light-transmissive digital spatial light modulator L (not shown). The advantage of this structure is the more compact design, since an additional spacer layer can be obviated.

FIG. 9 shows another inventive embodiment, in which a reflectively acting holographic optical element 13 is used. The light beam 12 is shone into the light guide plate 1. The light passes through the holographic optical element 13 in the out-coupling device 2 in the backward direction and is diffracted at the position 14 under the Bragg condition. The holographic optical element 13 diffracts the beam into a divergent diffuse beam which, after exiting the light guide plate 1, directly strikes the diffuser 5 which then again generates an angular dispersion so that there is homogeneous and divergent flat light during illumination of the light-transmissive digital spatial light modulator L (not shown). The advantage of this structure is the more compact design, since an additional spacer layer can be obviated.

It is furthermore possible to obviate the configurations of the diffuser 5 as represented in FIG. 5, FIG. 8 and FIG. 9, if the density and distribution of the holographic optical elements 13 in the transparent layer 2 is such that a sufficiently homogeneous light distribution is already achieved at the light-transmissive digital spatial light modulator L owing to the diffuser property of the elements 13. In particular when smaller holographic optical elements 13 and/or mutually overlapping holographic optical elements 13 are used, this is advantageous since the overall layer structure can be constructed more thinly.

FIG. 10 shows another inventive embodiment, in which a transmissively acting holographic optical element 13, which is read out in reflection, is used. The light beam 12 is shone into the light guide plate 1. After propagation by total reflection, it passes through the holographic optical element 13 in the out-coupling device 2 and is diffracted at the position 14 under the Bragg condition. The holographic optical element 13 diffracts the beam into a directional beam which, after exiting the light guide plate 1, first strikes a diffuser 5 where the light is divergently diffusely scattered. At position 16, this light then strikes a second diffuser 5, which again diffusely scatters it. The first diffuser 5 is used for the homogenization of the light intensity, and the second is used for the dispersion of the emission angles, in order to permit a wide angle view of the display 10. The advantage of this structure is the high diffraction efficiency which can be achieved with such a holographic optical element 13.

FIG. 11 shows an alternative embodiment to FIG. 10, in which a reflectively acting holographic optical element is used. The light beam 12 is shone into the light guide plate 1. The light passes through the holographic optical element 13 in the out-coupling device 2 in the backward direction and is diffracted at the position 14 under the Bragg condition. The holographic optical element 13 diffracts the beam into a directional beam which then, after exiting the light guide plate 1, strikes a first diffuser layer 6′ in the diffuser 5, where the light is divergently diffusely scattered. At position 16, this light then strikes a second diffuser layer 6′, which again diffusely scatters it. The first diffuser layer 6′ is used for the homogenization of the light intensity, and the second is used for the dispersion of the emission angles, in order to permit a wide angle view of the display. The advantage of this structure is the high diffraction efficiency which can be achieved with such a holographic optical element 13.

FIGS. 12-19 in turn show various embodiments with respect to the arrangement of the holographic optical elements in the out-coupling device 2. In this case, it is an oblique perspective view of the user side of the display. In FIG. 12, the light beam 12 propagating with total reflection is symbolized by an arrow. The emerging light beam 17 points perspectively at the observer. In this simplest embodiment, the holographic optical elements 13 are represented as circles. There is, however, no limitation on the shape selection. For instance, besides circular shapes, it is also possible to select ellipses, squares, triangles, quadrilaterals, trapeziums, parallelograms or any other desired shapes. The circles represented are only selected as such with a view to simplified graphical representation.

In general, the light density distribution in the edgelit case is not homogeneously distributed. FIG. 12 shows an example in which such a horizontal light density distribution is compensated for by the diffraction efficiency of the holographic optical elements 30 to 36 increasing. In this case, it may be advantageous to use only linear or geometrical changes in the diffraction efficiency, but likewise irregular varying diffraction efficiencies. This is advantageous particularly in the case of illumination effects at the corners of the waveguide or owing to the input coupling characteristic of the light sources.

FIG. 13 shows another possible arrangement to compensate for different light density distributions in the light guide plate 1. In this case, the distance between the holographic optical elements 40 to 46 varied. The advantage of this arrangement is that the holographic optical conditions can be selected to be equal in the production of all the holographic optical elements 13.

FIG. 14 shows another possible arrangement to compensate for different light density distributions in the light guide plate 1. In this case, the size of the holographic optical elements 50 to 56 is varied. The advantage of this arrangement is that the holographic optical conditions can be selected to be equal in the production of all the holographic optical elements 13.

FIG. 15 shows another possible arrangement to compensate for different light density distributions in the light guide plate 1. In this case, as in FIG. 14, the size of the holographic optical elements 13 is varied. In contrast thereto, different shape patterns of the holographic optical elements 60-61 are selected. The advantage of this arrangement is that the holographic optical conditions can be selected to be equal in the production of all the holographic optical elements 13.

FIG. 16 shows another possible arrangement to compensate for different light density distributions in the light guide plate 1. In this case, the direction of the diffraction planes of the holographic optical elements 70 to 73 is varied in 90° steps. The advantage of this arrangement is that light beams present in the light guide plate under total reflection can be coupled out more directly and therefore more efficiently. Such a design is likewise advantageous when the light sources are positioned on more than one edge of the light guide plate.

FIG. 17 shows another possible arrangement to compensate for different light density distributions in the light guide plate 1. In this case, the direction of the diffraction planes of the holographic optical elements 70 to 77 is varied in 45° steps. The advantage of this arrangement is that light beams present in the light guide plate under total reflection can be coupled out more directly and therefore more efficiently. Such a design is likewise advantageous when the light sources are positioned on more than one edge of the light guide plate 1. It should be pointed out that, in principle, any form of direction dependency of the holographic optical elements 13 may be used, and that there is no restriction to particular angles.

FIG. 18 shows another possible arrangement to compensate for different light density distributions in the light guide plate 1. In this case, the wavelength range (colour) in which the holographic optical elements 80 to 82 diffract is varied. In this case, it is appropriate to use chromatically narrow-emitting light sources, for example narrowly emitting light emitting diodes (LEDs), which have a bandwidth between 5-100 an, preferably 10-50 nm, and particularly preferably 10-35 nm. The advantage of this arrangement is that of compensating for the primary colours of specific light density distributions in the light guide plate 1. As already shown in FIG. 4, one primary colour is respectively served by each of the out-coupling devices 2a, 2b and 2c. Naturally, it is also possible to expose the holographic optical elements 80-82 into one layer 2, as shown in FIG. 1. It is, however, important for the layer thickness to be at least 5 μm in order to adjust a sufficiently narrow spectral Bragg condition.

In a related embodiment of FIG. 18, when using exclusively blue LEDs or laser diodes as the light source, it is also possible to use exclusively such holographic optical elements as are tuned to the wavelength of the blue light source. Red and green spectral components are obtained by applying suitable Q-dots on some of the holographic optical elements. The elements 80 to 82 then represent holographic optical elements on which either no Q-dots have been applied or Q-dots emitting red or green have been applied. Mixtures of Q-dots emitting red and green are also possible as a coating.

FIG. 19 shows another possible arrangement to compensate for different light density distributions in the light guide plate 1. In this case, the wavelength range (colour) in which the holographic optical elements 90-96 diffract light (for example, for blue all holographic optical elements denoted by 90, for red all those denoted by 91, and for green all those denoted by 92) is combined with the diffraction planes of the holographic optical elements (denoted by 93-96) and varied in 45° steps. The advantage is further adaptation and optimization of the light homogeneity.

FIG. 20 shows another possible arrangement to compensate for different light density distributions in the light guide plate 1. This is related to that in FIG. 18, where spectrally differently diffracting holographic optical elements 101-103 are being used. In FIG. 20, the holographic optical elements 101-103 are positioned partially overlapping one another and have a high diffraction efficiency for a particular visible light wavelength range. This is possible by using three separate layers positioned on one another or by construction in one layer. The first has the advantage that the requirement for the dynamic range of the recording medium (i.e. the ability to produce holographic gratings) is lower and the production of the layers can be carried out separately, while the second possibility exhibits a simplified structure, which makes it possible to produce thinner layer constructs.

FIG. 20 shows a case which can be produced by means of negative and positive masks. The desensitizing of the recording material is carried out using a negative mask, so that the regions without a holographic optical element are thereby defined. Subsequently, the red, green and blue holographic optical elements are written sequentially into the recording material with the respective lasers using three positive masks.

FIG. 21 shows a particularly preferred arrangement of the holographic optical elements 13, to compensate for different light density distributions in the light guide plate 1, which is illuminated by two light sources 110. The holographic optical elements 13 have the same size, diffraction efficiency and diffraction direction, and the homogeneous light distribution in the transparent layer 2 being made possible by different density distribution and arrangement of the holographic optical elements 13 with respect to the two light sources 110. In this case, the number of holographic optical elements 13 per unit area increases from those edges on which the light sources 110 are located in the direction of the middle of the light guide plate 1.

FIG. 22 shows another possible arrangement to compensate for different light density distributions in the light guide plate 1, which is illuminated by two light sources 110. The holographic optical elements 30-35 have a different diffraction efficiency with the same diffraction direction. Furthermore, the holographic optical elements 30-35 overlap one another.

### LIST OF REFERENCES

(1) light guide plate
(2) out-coupling device
(2a)-(2c) out-coupling device
(3) transmissive pixelated light modulator
(4) colour filter
(5) diffuser
(6) transparent layer
(6′) diffuser layer
(7) reflection layer
(8), (9) polarization filters (crossed)
(10) display
(10′) illumination unit
(11) light beam which does not correspond to the Bragg condition
(12) light beam which corresponds to the Bragg condition
(13) holographic optical element, volume gratings
(14) position of the diffraction of the light beam
(15) position at which no diffraction takes place
(16) position of the scattering in a diffuser
(17) divergent light beam
(20) light beam which corresponds to the Bragg condition
(21) light beams which do not correspond to the Bragg condition
(25) light beams which do not correspond to the Bragg condition
(26) positions at which no diffraction takes place
(30)-(36) holographic optical elements with the same size and different diffraction efficiency
(40)-(46) holographic optical elements with the same diffraction efficiency with different narrow spatial position with respect to one another
(50)-(56) holographic optical elements with different size
(60), (61) holographic optical elements in rectangular shape
(70), (71) holographic optical elements with diffraction efficiency in vertical orientation
(72), (73) holographic optical elements with diffraction efficiency in horizontal orientation
(74)-(77) holographic optical elements with diffraction efficiency in diagonal orientation
(80) holographic optical element with diffraction efficiency in the green wavelength range
(81) holographic optical element with diffraction efficiency in the red wavelength range
(82) holographic optical element with diffraction efficiency in the blue wavelength range
(90) holographic optical element with diffraction efficiency in the blue wavelength range
(91) holographic optical element with diffraction efficiency in the green wavelength range
(92) holographic optical element with diffraction efficiency in the red wavelength range
(93), (95) holographic optical elements with diagonal diffraction efficiency
(94) holographic optical element with horizontal diffraction efficiency
(96) holographic optical element with vertical diffraction efficiency
(101) overlapping holographic optical elements with diffraction efficiency in the green wavelength range
(102) overlapping holographic optical elements with diffraction efficiency in the red wavelength range
(103) overlapping holographic optical elements with diffraction efficiency in the blue wavelength range
(110) light source
L light modulator

1-22. (canceled)

23. A planar light distribution module for a display, comprising a light guide plate through which light coupled in via at least one side face can propagate by means of total reflection, and at least one out-coupling device, which is applied on one or both of the main faces of the light guide plate, is in optical contact therewith and has a multiplicity of holographic optical elements formed therein, which are configured in such a way that they can couple light out of the light guide plate, wherein the holographic optical elements, independently of one another, have an extent of at least 300 μm in at least one spatial axis extending parallel to the surface of the out-coupling device and an area at least 1.5 times as great as the pixels of the display.

24. The planar light distribution module according to claim 23, wherein the holographic optical elements, independently of one another, have an extent of at least 400 μm in at least one spatial axis extending parallel to the surface of the out-coupling device.

25. The planar light distribution module according to claim 23, wherein at least 30 holographic optical elements are arranged in the out-coupling device.

26. The planar light distribution module according to claim 23, wherein the holographic optical elements, independently of one another, have a circular, elliptical or polygonal, in particular three, four, five or six-sided, trapezoidal or parallelogram-like cross section in the surface of the out-coupling device, and/or in that the individual holographic optical elements of an out-coupling device partially overlap, the surface of the out-coupling device in particular being covered substantially fully with holographic optical elements.

27. The planar light distribution module according to claim 23, wherein the holographic optical elements are arranged irregularly in the out-coupling device.

28. The planar light distribution module according to claim 27, wherein there is no two-dimensional repetition series for the arrangement of the holographic optical elements in the out-coupling device and/or that the number of holographic optical elements per unit area increases from at least one edge in the direction of the middle of the out-coupling device.

29. The planar light distribution module according to claim 23, wherein the holographic optical elements are formed in the out-coupling device and extend from one of the flat sides of the out-coupling device into the latter and/or pass fully through it, the out-coupling device being, in particular, in contact with that flat side which has the light guide plate on which the holographic optical elements are located.

30. The planar light distribution module according to claim 23, wherein the out-coupling device or the light guide plate is provided with a reflection layer, which is applied on the flat side lying opposite the light out-coupling direction.

31. The planar light distribution module according to claim 23, wherein the diffraction efficiency of the holographic optical elements differs, the diffraction efficiency of the holographic optical elements increasing in particular along the direction of incidence for light into the light guide plate.

32. The planar light distribution module according to claim 23, wherein the holographic optical elements can couple light out of the light guide plate at least in the wavelength range of from 400 to 800 nm, and/or in that the holographic optical elements can couple light out wavelength-selectively, there being in particular at least three groups of holographic optical elements, which are respectively wavelength-selective for red, green and blue light.

33. The planar light distribution module according to claim 23, wherein the holographic optical elements are configured in such a way that the light coupled out by them passes fully through the out-coupling device transversely.

34. The planar light distribution module according to claim 23, wherein the holographic optical elements are configured in such a way that the light coupled out is reflected and passes transversely through the light guide plate after being coupled out.

35. The planar light distribution module according to claim 23, wherein the holographic optical elements are configured as volume gratings.

36. The planar light distribution module according to claim 23, wherein respectively at least one out-coupling device is arranged on both flat sides of the light guide plate, and/or at least two out-coupling devices are arranged on one flat side of the light guide plate.

37. The planar light distribution module according to claim 23, wherein at least three out-coupling devices, are arranged on one flat side of the light guide plate, the three out-coupling devices respectively containing holographic optical elements wavelength-selective for precisely one light colour, in particular for red, green and blue light.

38. The planar light distribution module according to claim 23, wherein the out-coupling device has a thickness of from 0.5 μm to 100 μm.

39. The planar light distribution module according to claim 23, wherein the out-coupling device contains a silver halide emulsion, a dichromatic gelatin, a photorefractive material, a photochromic material and/or a photopolymer.

40. The planar light distribution module according to claim 23, wherein at least one diffuser is arranged on that flat side of the light guide plate and/or out-coupling device on which the light is emitted.

41. The planar light distribution module according to claim 23, wherein the holographic optical elements have a diffuser function.

42. An optical display having a planar liquid-crystal module that comprises a multiplicity of pixels, which can be switched by means of a control unit, and a planar light distribution module comprising a light guide plate through which light coupled in via at least one side face can propagate by means of total reflection, and at least one out-coupling device, which is applied on one or both of the main faces of the light guide plate, is in optical contact therewith and has a multiplicity of holographic optical elements formed therein, which are configured in such a way that they can couple light out of the light guide plate in the direction of the planar liquid-crystal module, wherein the holographic optical elements, independently of one another, have an area at least 1.5 times as great as the pixels of the liquid-crystal module.

43. The optical display according to claim 42, wherein only light sources essentially emitting blue light are used, colour conversion to green and red light being carried out by means of Q-dots in a quantum rail in the light source, in the holographic optical elements of the out-coupling device, in a diffuser or in a colour filter.

44. The optical display according to claim 42, wherein the light distribution module is one according to claim 23.
